(19) United States
(12) Patent Application Publication
(10) Pub. No.: US 2010/0066720 A1
(43) Pub. Date: Mar. 18, 2010

(54) DATA DRIVER AND DISPLAY DEVICE

(76) Inventor: Kazuyoshi Kawabe, Kanagawa (JP)

Correspondence Address: EASTMAN KODAK COMPANY;PATENT LEGAL STAFF, 343 STATE STREET, ROCHESTER, NY, 14650-2201, US

(21) Appl. No.: 12/513,211

(22) PCT Filed: Nov. 1, 2007
(86) PCT No.: PCT/US07/23046

§ 371 Date: May 1, 2009

(30) Foreign Application Priority Data
Nov. 9, 2006 (JP) 2006-303992

(51) Int. Cl. G06F 3/038; G09G 5/36

(52) U.S. Cl. 345/213; 345/545

(57) ABSTRACT

A data driver, for sequentially supplying image data of each pixel to a display panel having pixels arranged in a matrix layout, for every line, includes a frame memory for storing pixel data having multiple-bits per single pixel in single screen segments; and a structure for converting from multiple-bit pixel data for a single line segment read out in single line units from the frame memory, into single bit pixel data corresponding to a subframe, in single frame units, wherein pixel data for a single line that has been converted to single-bit data by the conversion structure is output simultaneously for a single line.

### FIELD OF THE INVENTION

The present invention relates to display device, and more particularly to a data driver for driving the data lines, and to a data driver used in this display device.

### BACKGROUND OF THE INVENTION

Active matrix type organic EL displays are self emissive type, and so contrast is high, they have a wide viewing angle, and are also capable of high resolution and high definition detail, which is why they are attracting attention as the next generation displays.

Active matrix type displays require active elements in order to determine pixel display states one at a time, but in the case of an organic EL display a drive transistor capable of maintaining supply of current to the organic EL element is provided. A TFT (Thin Film Transistor) formed from a thin film of amorphous silicon, polysilicon etc. is used in the drive transistor, but small to medium sized organic EL displays adopting polysilicon TFTs that obtain stable drive for a prolonged period have been made commercially available.

However, polysilicon TFTs are prone to differences in characteristics between pixels, and if there are differences in characteristics, different current is output to an organic EL pixel even if the same signal is input, which makes if difficult to achieve display uniformity, and causes lower yield.

A method of correcting the characteristics of a polysilicon TFT using circuit technology has been proposed, and digital drive has been proposed as one such method (see WO 2005/116971).

Here, digital drive requires means for transferring data at high speed in order to write a single-bit supported subframe image to pixels multiple times within a single frame period.

### SUMMARY OF THE INVENTION

The present invention is characterized by a data driver, for sequentially supplying image data of each pixel to a display panel having pixels arranged in a matrix layout, for every line, comprising: a frame memory for storing pixel data having multiple-bits per single pixel in single screen segments; and conversion means for converting from multiple-bit pixel data for a single line segment read out in single line units from the frame memory, into single bit pixel data corresponding to a subframe, in single frame units, wherein pixel data for a single line that has been converted to single-bit data by the conversion means is output simultaneously for a single line.

Pixel data can be read out from the frame memory at a cycle that is shorter than a cycle for writing pixel data to the frame memory, and for pixel data having a greater plurality of bits to be converted to single bit pixel data corresponding to a subframe by the conversion means.

The conversion means can have a selector that receives multiple inputs in a number selectable based on single pixel data stored in the frame memory, and selects output from the multiple inputs based on single image data.

Inputs of the selector to be changed depending on a subframe.

Multiple subframe patterns can be made corresponding to one pixel data having multiple bits.

The image data can be divided into multiple channels, and have frame memories provided corresponding to the number of channels, respectively storing image data of each channel, and for the conversion means to sequentially convert image data of each channel read out from the frame memory.

The present invention is also characterized by a display device, comprising a display panel with pixels arranged at intersecting sections of multiple gate lines arranged in a row direction and multiple data lines arranged in a column direction, a gate driver for driving the gate lines, and a data driver for driving the data lines, in which the above described data driver is used as the data driver.

In this way, according to the present invention, data of a single line segment is read out from frame memory, and supplied to the display panel all at once.

Accordingly, there is no need to transfer data at a particularly high speed even if a single-bit supported subframe image is written multiple times to pixels within a single frame period.

### BRIEF DESCRIPTION OF THE DRAWINGS

FIG. 1 is a structural diagram of a practical example of a data driver IC of an embodiment;

FIG. 2 is a data input timing chart;

FIG. 3 is a gate driver internal structural diagram;

FIG. 4 is a 6-bit digital drive scan timing chart;

FIG. 5 is digital drive line selection and data output timing chart;

FIG. 6 is a structural diagram of a basic example of a data driver IC of an embodiment;

FIG. 7 is a pixel circuit diagram;

FIG. 8 is a read timing and write timing arbitration processing explanatory drawing;

FIG. 9 is an example of a subframe data register setting table; and

FIG. 10 is an 8-bit digital drive scan timing chart.

### DESCRIPTION OF THE PREFERRED EMBODIMENTS

Embodiments of the present invention will be described in the following based on the drawings.

This embodiment relates to a data driver for driving an active matrix type display device, and particularly to a data driver for digitally driving a display panel having self emissive type electroluminescence elements as display elements.

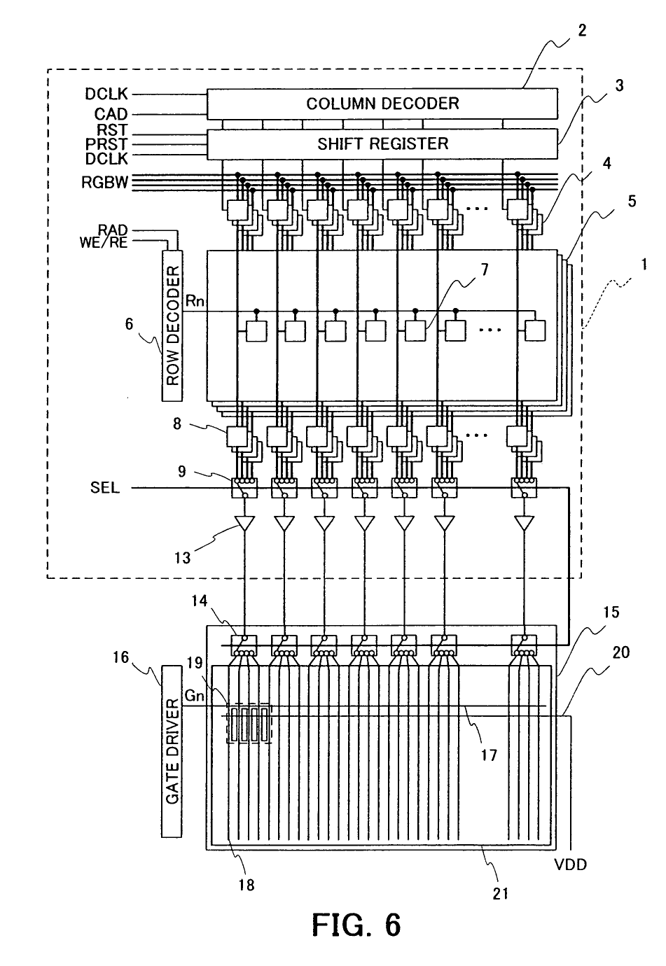

The overall structure of a display device including the data driver of the present invention is shown in FIG. 6. A data driver IC 1 includes a column decoder 2, a shift register 3, input data registers 4, frame memories 5, a row decoder 6, output data registers 8, a multiplexer 9, and an output buffer 13. Low power consumption SRAM (Static Random Access Memory) or low cost high capacity DRAM (Dynamic Random Access Memory) can be used as memory elements 7 constituting the frame memories 5, but non-volatile memory such as Flash memory that maintains data even if power is turned off is also suitable.

At the time of writing to memory, by decoding a column address CAD using the column decoder 2 data “1” is written to a register of an address corresponding to the shift register 3, this data “1” is transferred by a dot clock DCLK, and image data RGBW is sequentially incorporated into a corresponding input data register 4. Data stored in the input data register 4 is written in single line units to memory elements 7 selected by decoding the row address RAD with the row decoder 6.

When reading data, data of memory elements for a single line selected by decoding the row address RAD using the row decoder 6 is taken into the output data registers 8. Reading and writing of the frame memories 5 is switched using write enable WE and read enable RE.

Incidentally, since data is generally written at high speed from the input data registers 4 to the memory elements 7, and data are read at high speed from the memory elements 7 into the output data registers 8, drive circuitry such as sense amplifiers are provided, but these have been omitted from the drawing.

A method for the data driver IC 1 receiving image data input from outside and writing to the frame memories 5, and a method for reading image data from the frame memories 5 and outputting data to an organic EL panel 15, will be described in detail later, and first the organic EL panel 15 constituting an object to be driven will be described.

In the organic EL panel 15, pixels 19 having four colors of RGBW (red, green, blue, and white) in sub-pixels are arranged in a matrix format, with gate lines 17 for supplying selection signals to the pixels 19 arranged in the row direction and data lines 18 for supplying write data to the respective sub-pixels being arranged in the row direction. In the case where the pixels 19 are made up if sub-pixels of three colors RGB, the white pixel can be disregarded.

Data lines 18 provided corresponding to each row of the sub-pixels are formed on the same glass substrate as the organic EL panel 15, and data lines 18 for any of RGBW are connected to outputs of the data driver IC 1 via multiplexers 14 connected to one output of the data driver IC 1. Gate lines 17 provided on each line are respectively connected to outputs of each line of the gate driver 16. The gate driver 16 may be formed on the same glass substrate as the organic EL panel 15, or may be provided as an external IC. It is also possible to incorporate the gate driver into the data driver IC 1.

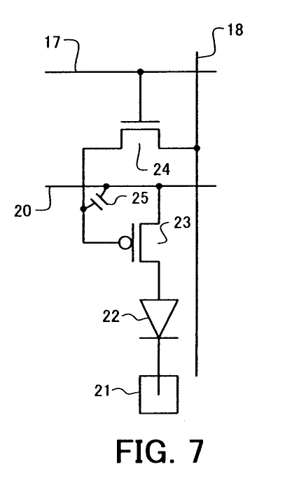

An equivalent circuit for each sub-pixel of a pixel 19 is shown in FIG. 7. Each sub pixel includes an organic EL element 22 of either RGB or W, a p-type drive transistor 23, an n-type gate transistor 24, and a storage capacitor 25. A source terminal of the drive transistor 23 is connected to a power line 20, the drain terminal is connected to an anode of the organic EL element 22, and the gate terminal is connected to one end of the storage capacitor 25 and the source terminal of the gate transistor 24. A gate terminal of the gate transistor 24 is connected to a gate line 17, the drain terminal is connected to data line 18, and the source terminal is connected to one end of the storage capacitor 25 and the gate terminal of the drive transistor 23. The other end of the storage capacitor 25 is connected to the power supply line 20.

The power supply line 20 and the cathode electrode 21 are respectively shared by all pixels of the organic EL panel 15, with a power supply voltage VDD being supplied to the power supply line 20 and a cathode voltage VSS being supplied to the cathode terminal 21.

With the equivalent circuit shown in FIG. 7, since the gate transistor 24 is n-type, if the gate line 17 is put in a “high” state the gate transistor 24 will conduct, and data supplied to the data line 18 is written to the storage capacitor 25, while if the gate line 17 is put in a “low” state the gate transistor becomes non-conducting and data written to the storage capacitor 25 is held. If the gate transistor 24 is p-type, this is reversed.

If the written data is a sufficiently low voltage to turn the drive transistor 23 on, current flows in the organic EL element 22 and light is generated, while conversely, if the data is sufficiently high to turn the drive transistor 23 off, current does not flow in the organic EL element 22 and it is turned off.

That is, the gate driver 16 supplies a voltage causing the gate transistor 24 to turn on or off, and the data driver IC 1 supplies a voltage to turn the drive transistor 23 on or off in accordance with a digital drive procedure.

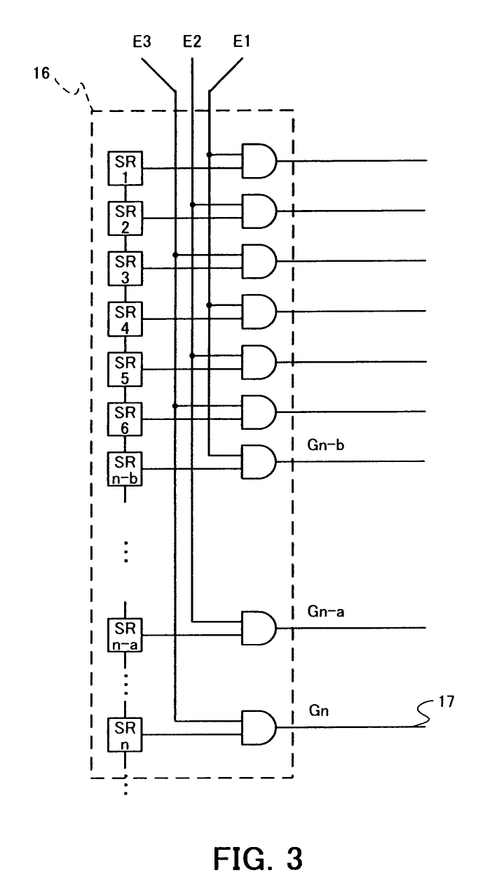

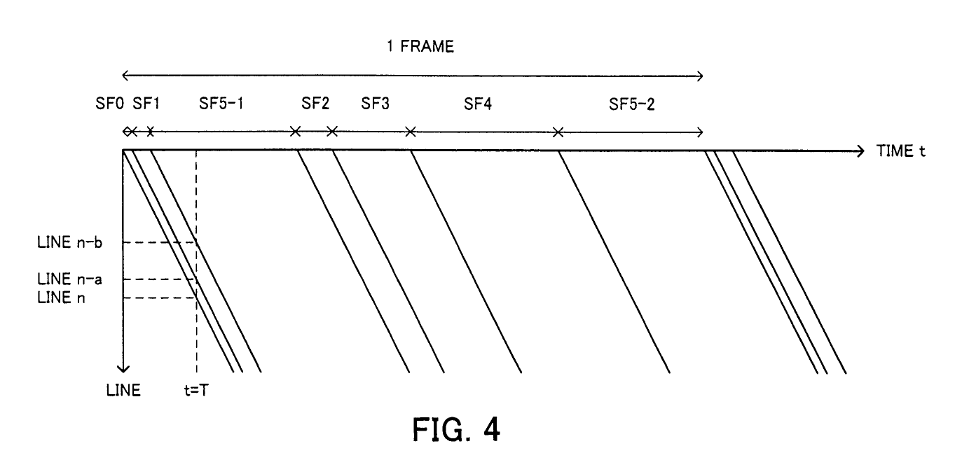

FIG. 4 is a scan timing chart for 6 bit digital drive realized using the present invention, and FIG. 3 shows the internal structure of a gate driver 16.

The timing chart of FIG. 4 shows an example of digital drive configured from sub-frames SF0-SF4 from bit 0 to bit 4, and a subframe for bit 5 further divided into two subframes SF5-1 and SF5-2, and shows elements implementing sequential scan of the subframes SF0, SF1, SF5-1, SF2, SF3, SF4 and SF5-2, in the line direction shown on the vertical axis with lapse of time, shown on horizontal axis.

In the gate driver shown in FIG. 3, shift registers (SR) at least the same in number as lines of pixels of the organic EL panel 15 are provided, outputs of each shift register are input to one input ( )an enable circuit (AND circuit), at least one of which is provided in each line, while the other input of the enable circuit is connected every three lines to the same enable control line of the enable control lines E1-E3.

Described in more detail, for an input of an enable circuit of an n^{th} line, if the remainder after diving n by 3 is 1, the input is connected to E1, if the remainder is 2 the input is connected to E2, and if the remainder is 0 the input is connected to E3. In this way, the gate line 17 of the n^{th} line is only active when the value of the shift register SRn is “high” and the enable control line connected to the enable circuit of the n^{th} line (here E3) is “high”.

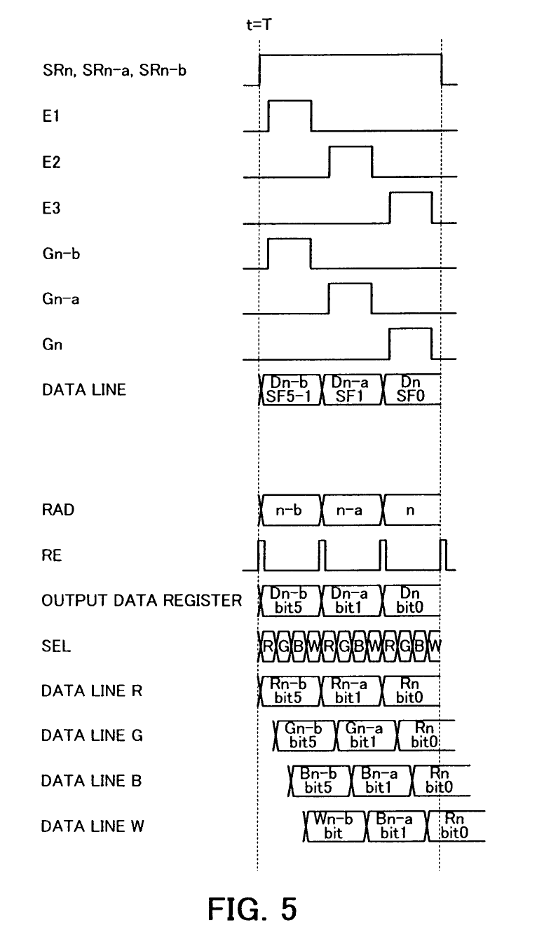

Operation of the gate driver 16 at time t=T in FIG. 4, will be described using FIG. 3 and FIG. 5. At time t=T, scanning of sub-frames SF0, SF1 and SF5-1 is simultaneously generated at the n^{th} line, n-a^{th} line and n-b^{th} line, but if these three gate lines 17 are selected simultaneously the data supplied to the data line 18 will be simultaneously written to three lines, which means desired display will not be obtained. It is therefore necessary for the write lines to be respectively selected in order, but this function is realized using the enable circuits and enable control lines E1 to E3 provided in the gate driver 16.

FIG. 5 shows signals of the enable control lines E1 to E3 at time t=T, and selection states of the gate lines Gn, Gn-a and Gn-b the n^{th}, n-a^{th} and n-b^{th} lines. At time t=T, if data is input to the shift register SR so that “High” is input the shift registers SRn, SRn-a and SRn-b inside the gate driver 16, and, for example, the enable control lines are made “high” in the order E1, E2 and E3, from the connection relationship shown in FIG. 3 the gate lines 17 will be selected in the order Gn-b, Gn-a, Gn.

If data Dn-b for SF5-1, data Dn-a for SF1 and data Dn for SF0, being subframes of the n-b^{th} line, n-a^{th} line and n^{th} line, is supplied to each data line 18 coincident with the times of selecting Gn-b, Gn-a and Gn, the respective subframes will be written to each line. After that, if the same operations are sequentially executed in all periods for the lines selected in accordance with the passage of time in FIG. 4, writing of remaining lines and remaining subframes is executed without discrepancy.

Specifically, the data driver IC 1 performs reading and writing of input data to and from the frame memories 5, and it is necessary to output data to the data line 18 at the timing shown in FIG. 5.

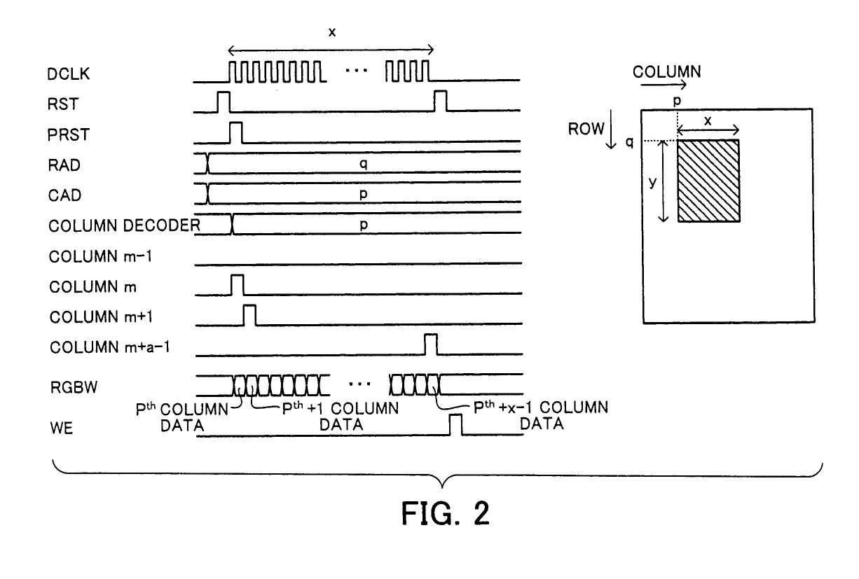

First, a method of writing input data to the frame memories 5 will be described using FIG. 2 and FIG. 6. With this example, as shown on the right side of FIG. 2, a write control example for an arbitrary rectangular region will considered, where with the q^{th} row, p^{th} column as a starting point, only a window region of x pixels horizontally and y pixels vertically is updated, and outside this region an image already written in the fame memories 5 is maintained. As shown in the left side of FIG. 2, all data of the shift register 3 is reset to “0” by an RST pulse, and if at this time a row address g where writing starts is input to the row address input RAD of the row decoder 6 data of one line segment of the row address q is read into the input data registers 4. At the same time, a columns address q where writing starts is input to the column address input CAD of the column decoder 2, and then if decode data having only shift registers of the p^{th} column set to “1” in the shift register 3 by a PRST pulse for presetting the input decode data are set, the shift register connects only input data registers of the p^{th} column to the data bus RGBW. At this time, if the dot clock DCLK (clock dot bringing data into the input data registers) is input, then only data of the p^{th} column, of the data of the q^{th} line read into the input data registers 4, is updated with new data.

Subsequently, by inputting the dot clock DCLK and data of the p+1^{th}, p+2^{th}, p+x−1^{th} columns, data of the p+1^{th}, p+2^{th}, . . . , p+x−1^{th} columns, of the data of the q^{th} line read into the input data registers 4, is updated, and by supplying a write timing WE pulse while the row address decode input is q the data of that single line is written to the memory elements 7 of the q^{th} line. By repeating this for the q+1^{th}, q+2^{th}, q+y−1^{th} lines, data for the window region shown in FIG. 2 in the frame memories 5 is updated.

In the case where control to only update the arbitrary rectangular region while not updating other regions is carried out in line units using the input data registers 4 in this way, by using input data registers 4 that are capable of acquiring data from both the input bus RGBW and the frame memories 5, and first setting, using a switching signal (not shown), so as to read data from the frame memories 5 and reading data held in the fame memories 5 for lines constituting a temporary update target to the input data registers 4, and then switching input to the input data bus RGBW, receiving column data to be updated from the input data bus RGBW and an input for that column address from the column address input CAD and rewriting date read into the input data registers 4, it is possible to omit input of unnecessary data that is not the subject of update.

Next, a method of data read for the frame memory 5 in order to output data to the organic EL panel 15 will be described using FIG. 5 and FIG. 6. As described previously, if the digital drive shown in FIG. 4 is used, the data driver IC 1 must output data to the data lines 18 at the timing shown in FIG. 5. Therefore, first n-b is set on the row address input RAD, data for bit 5 (MSB of 6-bit data) of the four colors RGBW (four channels) for the n-b^{th} line is read into the single bit output data register 8 by the read data acquisition timing pulse RE.

The four color RGBW data (bit 5 data) entered into the output data register 8 is output to each of the respective RGBW data lines 18 in RGBW order by multiplexers 14 switched by a select signal SEL.

If the enable control line goes from “high” to “low” at the time of completion of output of the final RGBW four color data, the gate transistor becomes non-conducting, and the bit 5 data Rn-b, Gn-b, Bn-b and Wn-b for the n-b^{th} line of the RGBW supplied to the data lines 18 is stored in the storage capacitor of each sub-pixel of the n line.

Similarly for remaining lines also, it is possible to set row address input RAD to n-a, n and read out bit 0 data (LSB of 6-bit data) of the n-a^{th} line and the n^{th} line, and divide that data to each data line 18 using the multiplexers 14 to write respective data to each sub-pixel of the pixel 19.

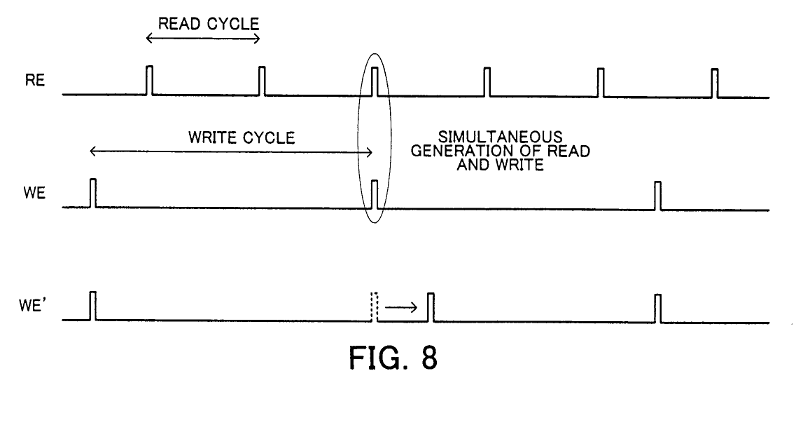

However, with digital drive, as shown in FIG. 8, the write cycle and the read cycle are different when reading and writing to and from the frame memory 5, which means that there may be occasions when a read and a write are generated at the same time (read enable RE and write enable WE are high at the same time). In this case, the read timing is maintained, and only when a read and a write occur at the same time is the write timing delayed, as shown by the WE′ signal, and by reading data first it is possible to prevent the read data being overwritten by the write data.

As described above, if the data driver IC 1 with built in multiple output memory is used, data of the frame memory 5 can be read and output in single line units, which means that it is possible to output data to the organic EL panel 15 at high speed, and it is possible to adopt digital drive even if the organic EL panel is high resolution.

Here, with the example of FIG. 6, it is possible to realize digital data drive by scanning six sub-frames as shown in FIG. 4, but is limited to combination of one sub-frame for singe data, that is, to a single emission duty cycle, and the range of contrast representation is limited. For example, in the case where data “34” is input, a combination of subframes SF1, SF5-1 and SF5-2 illuminated, with the other subframe not illuminated, is uniquely determined. However, if variation in actual light emission efficiency and chromatic coordinates of the organic EL elements are taken into consideration, the extent to which it is possible to generate the same brightness and color for the same data is limited, and it is more desirable to have a degree of freedom to change combinations of subframes to a certain extent even if the same data is input, from the point of view of control.

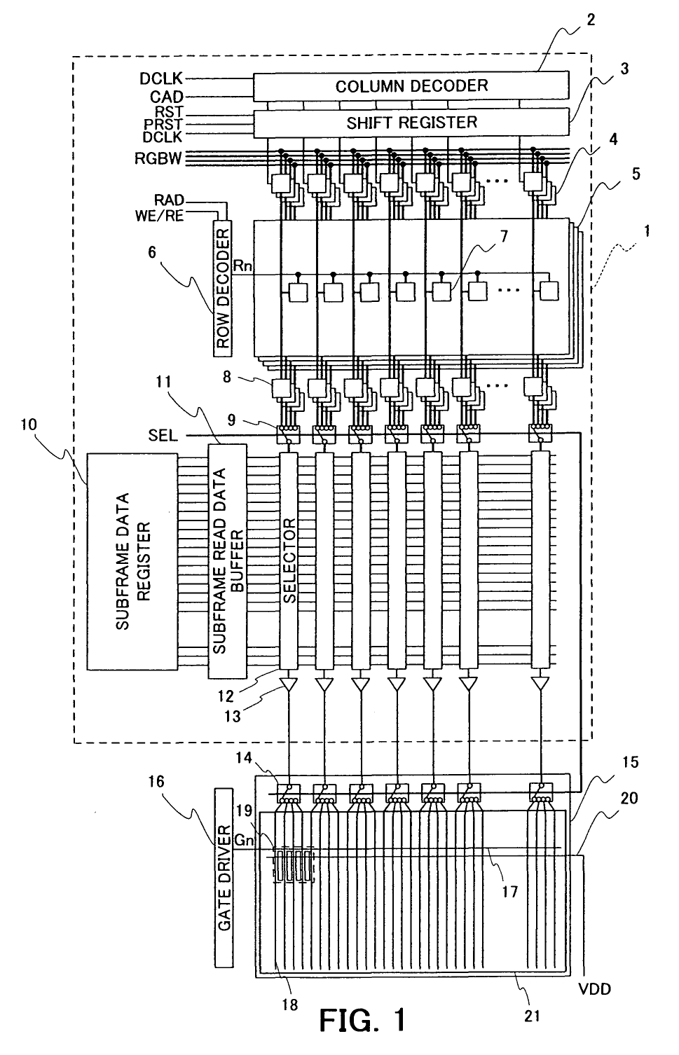

FIG. 1 shows an example where a function of being able to change combinations of subframes is introduced. The point of difference from the example of FIG. 6 is that there are processing sections after the reading of data of the sub-frames 5, so detailed description will be given below of this point.

In the case of the structure of FIG. 6, the output data register 8 was a single bit register, but in the case of FIG. 1 the output data registers 8 are 6-bit registers.

At the time of memory read, RGBW respective 6-bit data of the read out n^{th} line is taken into the 6-bit output registers 8 for a single line segment. The data is then sent to selectors 12 for selecting single data from 64 input data. Data entered into the sub-frame read data buffer 11 from the subframe data register 10 according to subframe is input to the 64 inputs of the selectors 12, and a single bit is selected from that 64 bit data in the selector 12 and output to the output buffer 13.

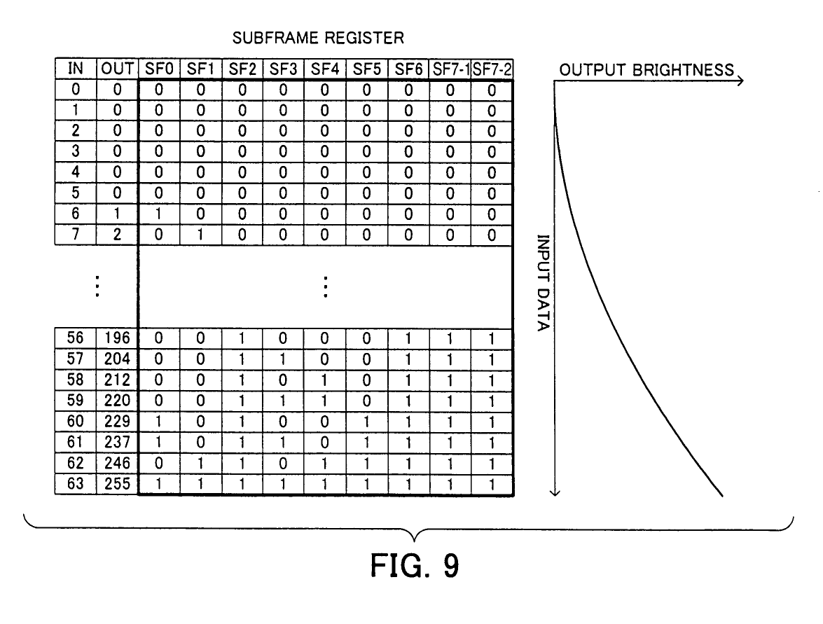

Conversion data as shown in FIG. 9 is stored in the subframe data register 10. The subframe data register 10 is for converting the 6-bit data from the output data register 8 (shown as IN) to 8-bit data (shown as OUT), and the values of SF0 to SF7 (SF7-1, SF7-2) corresponding to that line correspond to the values of OUT. Then, depending on what subframe is output to the display panel, 64 items data for a column of the corresponding subframe are supplied to each selector 12 via the subframe read data buffer 11, and each selector 12 selects a single bit from among the 64 inputs according to the data from the output data register 8.

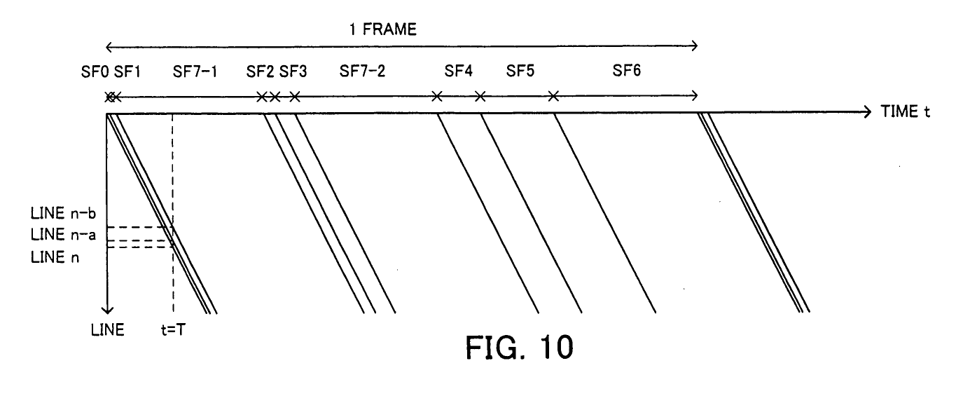

Specifically, FIG. 9 shows an example where digital drive to generate 8 bits using nine subframes as shown in FIG. 10 is implemented, and 6-bit data is converted to 8-bits.

The subframes shown in FIG. 10 divide bits into two subframes SF7-1 and SF7-2, and are configured so that they can be realized using the gate driver 16 of FIG. 3. That is, in the case where the shift registers of the gate driver 16 are capable of selecting three different lines, it is possible to write different subframe data of different lines that are selected in a time divided manner using the enable control lines E1, E2 and E3 respectively to a maximum of three lines of pixels.

Digital drive is capable of realizing 8-bit gradation as in FIG. 10, but since input data is 6-bit, data conversion to 8-bits is required. The right side of FIG. 9 shows the case of converting, for example, output data to input data so as to give a particular curve. Data after conversion becomes 8-bit data, and operation for each subframe, that is, whether to make it ON or OFF, is determined.

At time t=T in FIG. 10, that is, in the period where the nth line, n-a^{th} line and n-b^{th} line are selected, in the event that data of subframe SF7-1 is written to the n-b^{th} line 64-bit data (00000000 . . . 11111111) of SF7-1 of the subframe data register 10 is entered into the subframe read data buffer 11, and output to the 64 inputs of the selector 12. However, the way in which data is arranged is in ascending order of the 6-bit input data IN of FIG. 9.

The selector 12 selects corresponding single bit data from the 64-bit data (64 items of data for a column of subframe SF7-1 in FIG. 9) input in the subframe SF7-1 using the value of 6-bit input data stored in the output data register 8, and outputs to the output buffer 13. In this way, for the n-b^{th} line, corresponding bits of subframe SF7-1 are selected from the selector 12 of each column when image data at that time has been converted to 8-bits.

At the n-a^{th} line 64-bit data (00000001 . . . 00000011) of SF1 are output to the input of the selector 12, and at the n^{th} line 64-bit data (00000010 . . . 00001101) of SF0 are output to the input of the selector 12, and single bits are selected from among that 64-bit data using the 6-bit data stored in the output data register 8, and output to the output buffer 13.

The subframe data registers are provided respectively divided into RGBW, and the respectively different input output relationships have increased freedom than if defined as on the right of FIG. 9. In that case, by switching respective subframe data registers 10 of RGBW using the select signal SEL and reading the data for 64 input from the corresponding subframe data register 10 into the subframe read data buffer 11, it is possible to share the selectors 12 among RGBW.

By providing the subframe data registers 10, subframe read data buffers 11 and selector 12, as in FIG. 10, to introduce more subframes, it is possible to define subframe patterns for generating different light emission periods even with the same input data without increasing the capacity of the frame memory 5, and it is therefore possible to cancel out variations in characteristics of the organic EL elements with manufacture.

Incidentally, data setting for defining correspondence between input data and output data, carried out for the subframe data registers 10, can be carried out once when turning on power to the display. Alternatively, it is also possible to prepare in advance pre-defined data according to display content, and changing correspondence dynamically.

Also, with this embodiment, inputs of the data driver IC 1 are the four colors RGBW, but it is also possible to have inputs as the three colors RGB and add conversion circuits for converting RGB to RGBW, and then input the converted RGBW data to the input data registers 4.

### PARTS LIST

1 data driver IC

2 column decoder

3 shift register

4 input data registers

5 frame memories

6 row decoder

7 memory elements

8 output data registers

9 multiplexer

10 subframe data register

11 sub-frame read data buffer

12 selectors

13 output buffer

14 multiplexers

15 organic EL panel

16 gate driver

17 gate lines

18 data lines

19 pixels

20 power line

21 cathode electrode

22 organic EL element

23 drive transistor

24 gate transistor

25 storage capacitor

64 display panel

1. A data driver, for sequentially supplying image data of each pixel to a display panel having pixels arranged in a matrix layout, for every line, comprising:
a frame memory for storing pixel data having multiple-bits per single pixel in single screen segments; and
conversion means for converting from multiple-bit pixel data for a single line segment read out in single line units from the frame memory, into single bit pixel data corresponding to a subframe, in single frame units, wherein
pixel data for a single line that has been converted to single-bit data
by the conversion means is output simultaneously for a single line.

2. The data driver of claim 1, wherein:
pixel data are read out from the frame memory at a cycle that is shorter than a cycle for writing pixel data to the frame memory, and pixel data having a greater plurality of bits is converted to single bit pixel data corresponding to a subframe by the conversion means.

3. The data driver of claim 1, wherein:
the conversion means has a selector that receives multiple inputs in a number selectable based on single pixel data stored in the frame memory, and selects output from the multiple inputs based on single image data.

4. The data driver of claim 1, wherein:
inputs of the selector are changed depending on a subframe.

5. The data driver of claim 1:
capable of making multiple subframe patterns correspond to the same pixel data having multiple bits.

6. The data driver of claim 1, wherein:
the image data is divided into multiple channels, and the frame memory is provided corresponding to the number of channels, respectively storing image data of each channel; and
the conversion means sequentially converts image data of each channel read out from the frame memory.

7. A display device, comprising a display panel with pixels arranged at intersecting sections of multiple gate lines arranged in a row direction and multiple data lines arranged in a column direction, a gate driver for driving the gate lines, and a data driver according to claim 1 for driving the data lines.
